(19) United States
(12) Patent Application Publication
(10) Pub. No.: US 2005/0145319 A1
(43) Pub. Date: Jul. 7, 2005

(54) Unfired, adhesive ceramic film

(76) Inventors: Anja Neubert, Reutlingen (DE); Walter Roethlingshoefer, Reutlingen (DE)

Correspondence Address: STRIKER, STRIKER & STENBY, 103 EAST NECK ROAD, HUNTINGTON, NY, 17743, US

(21) Appl. No.: 10/979,476

(22) Filed: Nov. 2, 2004

(30) Foreign Application Priority Data
Nov. 3, 2003 (DE) 103 51 209.8

(51) Int. Cl. C03B 29/00; C09J 1/00; B32B 31/00

(52) U.S. Cl. 156/89.11; 156/247

(57) ABSTRACT

The invention relates to an unfired, adhesive ceramic film (1) having an unfired ceramic film (10) and an adhesive film (30), as well as to a method for producing a ceramic film (1) of the invention.

### PRIOR ART

The invention is based on an unfired (green) ceramic film with an adhesive coating as generically defined by the preamble to the main claim. From German Patent Disclosure DE 100 43 202 A1, a method for producing an unfired ceramic film is known in which a ceramic slip is applied to an uncoated substrate film of PET (polyethyleneterepthalate), and after the drying of the ceramic slip, the unfired ceramic film is peeled off the substrate film. For better separation of the unfired ceramic film from the substrate film, the substrate film is coated with parting agents that contain oil.

For producing a multi-layer ceramic, the unfired ceramic films are typically provided with conductor tracks and plated-through holes and arranged in a stack. This stacking is done with high precision, in order to assure a perfect electrical connection among the various layers of the ceramic films. However, after the stacking, the unfired ceramic films are not yet solidly joined together, and particularly under thermal and/or mechanical stresses, they can become shifted relative to one another. If a stack of that kind were fired immediately, it would have to be assumed that the layers of the ceramic stack would shift because of the high pressures exerted and the outgassing of organic ingredients, and the electrical function would no longer be assured. To prevent this loss of quality, it is standard for such ceramic stacks to be “hot laminated” before sintering. To that end, the ceramic stack is exposed a temperature of up to 100° C. or possibly higher for from 0.5 to 3 minutes, at a pressure of 50 to 130 kg/cm³. This causes volatile organic ingredients to evaporate and “bakes” the individual ceramic layers together. This first “baking together” is sufficient to fix the individual ceramic layers in their position during sintering.

### Advantages of the Invention

The unfired, adhesive ceramic film of the invention having the definitive characteristics of the main claim has the advantage over the prior art that when a multi-layer ceramic is produced, the “hot lamination” can be dispensed with. Thus one process step is advantageously saved, and additional sources of error are avoided. Furthermore, even during the stacking, the individual ceramic layers are fixed, and the quality of the electrical transitions is thus further enhanced.

By the provisions in the dependent claims, advantageous refinements and improvements to the unfired, adhesive ceramic film defined by the independent claim are possible.

In a further advantageous refinement, the unfired, adhesive ceramic film is produced by first placing an adhesive coating on a substrate film, and then applying a ceramic slip on the adhesive coating. Drying of the ceramic slip causes an unfired ceramic film to form. When this unfired ceramic film is peeled off, the adhesive coating essentially remains stuck to the unfired ceramic film, so that in further processing, the unfired, adhesive ceramic film can advantageously be fixed on further substrates, such as further ceramic films.

In another advantageous refinement, a plurality of unfired, adhesive ceramic films are arranged in a stack, and the individual layers of the stack are advantageously fixed via the adhesive coating of the unfired, adhesive ceramic films.

In a further advantageous refinement, at least one unfired, adhesive ceramic film is disposed on an unfired ceramic film without an adhesive coating. This has the advantage that at least for the first layer in a ceramic stack, a conventional unfired ceramic film can be used.

In a further advantageous refinement, conductor tracks are disposed on the unfired, adhesive ceramic films, and/or plated-through holes are made in them. This is advantageously done in such a way that the unfired, adhesive ceramic film can be inserted into the usual production process.

In another advantageous refinement, the organic ingredients, and in particular the adhesive coating, of the unfired, adhesive ceramic film are degraded in the firing process. Thus the adhesive coating can advantageously be used, for instance in lamination, without there being problematic residues of the adhesive coating remaining in the finished fired ceramic.

### DRAWINGS

Exemplary embodiments of the invention are shown in the drawings and explained in further detail in the ensuing description.

FIG. 1 shows an unfired, adhesive ceramic film of the invention;

FIG. 2 shows a method for producing an unfired, adhesive ceramic film of the invention; and

FIG. 3 shows a multi-layer ceramic.

### DESCRIPTION OF THE EXEMPLARY EMBODIMENTS

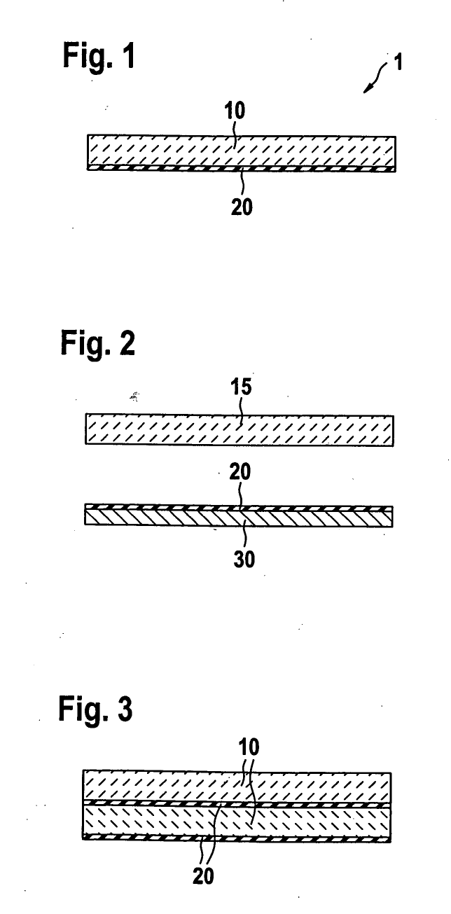

In FIG. 1, an unfired, adhesive ceramic film 1 of the invention is shown, comprising an unfired (“green”) ceramic film 10, with an adhesive coating 20 disposed on one flat side.

The green ceramic film 10 typically comprises a ceramic powder, an inorganic binder, and an organic binder.

Among other materials, permanent-elastic adhesives based on methacrylate, which burn without residue, are suitable as the adhesive coating 20. FIG. 2 shows one possible production process for a fired, adhesive ceramic film 1 of the invention. In a first step, an adhesive coating 20 is placed on a substrate film 30. In a further step, a ceramic slip 15 is applied to the substrate film 30 that has been provided with the adhesive coating 20. A green or in other words unfired ceramic film 10 is formed by drying of the ceramic slip 15. The adhesive coating 20 is adjusted such that when the green ceramic film 10 is peeled off, the adhesive coating 20 essentially remains stuck to the green ceramic film 20.

The ceramic slip 15 typically comprises from 40 to 60 weight percent ceramic powder; the rest is divided among water and the binder and small proportions of additives. As the substrate films 10, standard polymer films such as PE (polyethylene), PET (polyethyleneterephthalate) or PP (polypropylene) are suitable, but still other polymer films are also conceivable.

The adhesive coating 20 may be applied by being rolled on, or by screen printing, spraying, casting, or other methods.

In combination with the substrate film 30, the unfired, adhesive ceramic film 1 of the invention can be inserted into the usual course of a hybrid production process. In particular, via screen printing, for instance, conductor tracks can be disposed on the green ceramic film 10, or recesses for plated-through holes can be made. The recesses extend from the green ceramic films 10 through the adhesive coating 20 into the substrate film 30 and, depending on the intended use, are for instance filled with a conductive paste.

FIG. 3 shows a stack with two unfired, adhesive ceramic films 1, one above the other, for producing a multi-layer ceramic. Such an arrangement has the advantage that even when an unfired, adhesive ceramic film is applied, the ceramic layer is secured by the adhesive coating 20 and is also kept in that position in the further processing steps. Moreover, the particular advantage in the makeup of a multi-layer ceramic with an unfired, adhesive ceramic film 1 of the invention is that the typical “hot lamination” before the firing process can be dispensed with.

1. An unfired, adhesive ceramic film (1), having an unfired ceramic film (10), and an adhesive coating (30).

2. A method for producing an unfired, adhesive ceramic film (1) of claim 1, having the following steps:
a) Applying an adhesive coating (20) to a substrate film (30);
b) Applying a ceramic slip (15) to the substrate film (30) that is provided with the adhesive coating (20);
c) Forming an unfired ceramic film (10) by drying the ceramic slip (15);
d) Peeling off the unfired ceramic film (10) from the substrate film (30), whereupon the adhesive coating (20) separates from the substrate film (30) and remains essentially stuck to the unfired ceramic film (10).

3. A method for producing a multi-layer ceramic, beginning with unfired, adhesive ceramic films (1) of claim 1, characterized in that a plurality of unfired, adhesive ceramic films (1) are disposed in a stack (100).

4. The method for producing a multi-layer ceramic of claim 3, characterized in that at least one unfired, adhesive ceramic film (1) is disposed on an unfired ceramic film (10) without an adhesive coating (20).

5. The method for producing a multi-layer ceramic of claim 3, characterized in that conductor tracks are disposed on the unfired ceramic adhesive films (1), and/or unfired ceramic adhesive films (1) have plated-through holes.

6. The method for producing a multi-layer ceramic of claim 3, characterized in that in firing the unfired adhesive ceramic adhesive films (1), the organic ingredients, in particular those of the adhesive coating (20), are degraded.
